(19) United States
(12) Patent Application Publication
(10) Pub. No.: US 2005/0282714 A1
(43) Pub. Date: Dec. 22, 2005

(54) Dust control wipe

(76) Inventors: Louis Oldenhove, Liege (BE); Marianne Mahieu, Ayeneux (BE); Philip Gorlin, Flemington, NJ (US)

Correspondence Address: COLGATE-PALMOLIVE COMPANY, 909 RIVER ROAD, PISCATAWAY, NJ, 08855, US

(21) Appl. No.: 11/123,997

(22) Filed: May 6, 2005

Related U.S. Application Data
(63) Continuation-in-part of application No. 10/688,634, filed on Oct. 17, 2003.

(51) Int. Cl. C11D 1/00

(52) U.S. Cl. 510/109

(57) ABSTRACT

The present invention relates to a dust control wipe comprising a water insoluble substrate impregnated with a dust control composition containing an anionic surfactant, a dust control agent and water.

### RELATED APPLICATION

This application is a continuation in part application of U.S. Ser. No. 10/688,634 filed Oct. 17, 2003.

### FIELD OF THE INVENTION

This present invention relates to a dust cleaning wipe which contains a dust control composition, wherein the dust cleaning wipe is applied to a surface to be treated for the prevention of the deposit of dust on such surface.

### BACKGROUND OF THE INVENTION

The prevention of the deposition of dust on substrates such as glass, wood or plastic is a significant cleaning problem. Dust particles from the air are constantly depositing on surfaces and are an ideal place for dust mites to reside in. The present invention relates to a dust control wipe which when applied to a substrate prevents the deposition of dust on the substrate thereby minimizing the growth of dust mites.

### SUMMARY OF THE INVENTION

The present invention provides a dust control wipe comprising by weight:
(a) from about 15% to about 60% of a water insoluble substrate; and
(b) from about 40% to about 85% of a dust control composition which comprises by weight:
(i) from about 0.1% to about 5.0% of at least one anionic surfactant; and
(ii) from about 0.01% to about 4.0% of a dust control agent, which is selected from the group consisting of alkylolamine methosulfate and choline chloride.

### DETAILED DESCRIPTION OF THE INVENTION

The present invention relates to a dust cleaning wipe which comprises by weight:
(a) from about 15% to about 60%, more preferably 20% to 45% of a water insoluble substrate; and
(b) from about 40% to about 85%, more preferably 55% to 80% of a dust control composition which is impregnated into said water insoluble substrate, wherein said chemical composition comprises approximately by weight:
(i) from about 0.01% to about 5.0%, more preferably 0.5% to 2.5% of at least one anionic surfactant;
(ii) from about 0.01% to about 4.0%, more preferably 0.01% to 1.0% of a dust control agent which is selected from the group consisting of choline chloride and a quaternized alkylolamine methosulfate having about 2 to about 18 carbon atoms, more preferably about 4 to about 16 carbon atoms;
(iii) 0 to 5%, more preferably 0.5% to 4% of a C₂-C₄ alkanol such as ethanol or isopropanol;
(iv) 0 to 6%, more preferably 0.5% to 2.5% of at least one water soluble cosurfactant; and
(v) water.

Suitable water-soluble non-soap, anionic surfactants include those surfactant compounds which contain an organic hydrophobic group containing generally 8 to 26 carbon atoms and preferably 10 to 18 carbon atoms in their molecular structure and at least one water-solubilizing group selected from the group of consisting of sulfonate, sulfate and carboxylate so as to form a water-soluble surfactant. Usually, the hydrophobic group will include or comprise a C₈-C₂₂ alkyl, alkyl or acyl group. Such surfactants are employed in the form of water-soluble salts and the salt-forming cation usually is selected from the group consisting of sodium, potassium, or magnesium, with the sodium and magnesium cations again being preferred.

Examples of suitable sulfonated anionic surfactants are the well known higher alkyl mononuclear aromatic sulfonates such as the higher alkyl benzene sulfonates containing from 10 to 16 carbon atoms in the higher alkyl group in a straight or branched chain, C₈-C₁₅ alkyl toluene sulfonates and C₈-C₁₅ alkyl phenol sulfonates.

A preferred sulfonate is linear alkyl benzene sulfonate having a high content of 3- (or higher) phenyl isomers and a correspondingly low content (well below 50%) of 2- (or lower) phenyl isomers, that is, wherein the benzene ring is preferably attached in large part at the 3 or higher (for example, 4, 5, 6 or 7) position of the alkyl group and the content of the isomers in which the benzene ring is attached in the 2 or 1 position is correspondingly low. Particularly preferred materials are set forth in U.S. Pat. No. 3,320,174.

Other suitable anionic surfactants are the olefin sulfonates, including long-chain alkene sulfonates, long-chain hydroxyalkane sulfonates or mixtures of alkene sulfonates and hydroxyalkane sulfonates. These olefin sulfonate surfactants may be prepared in a known manner by the reaction of sulfur trioxide (SO₃) with long-chain olefins containing 8 to 25, preferably 12 to 21 carbon atoms and having the formula RCH═CHR₁ where R is a higher alkyl group of 6 to 23 carbons and R₁ is an alkyl group of 1 to 17 carbons or hydrogen to form a mixture of sultones and alkene sulfonic acids which is then treated to convert the sultones to sulfonates. Preferred olefin sulfonates contain from 14 to 16 carbon atoms in the R alkyl group and are obtained by sulfonating an a-olefin.

Other examples of suitable anionic sulfonate surfactants are the paraffin sulfonates containing 10 to 20, preferably 13 to 17, carbon atoms. Primary paraffin sulfonates are made by reacting long-chain alpha olefins and bisulfites and paraffin sulfonates having the sulfonate group distributed along the paraffin chain are shown in U.S. Pat. Nos. 2,503,280; 2,507,088; 3,260,744 and 3,372,188.

Examples of satisfactory anionic sulfate surfactants are the C₈-C₁₈ alkyl sulfate salts and the ethoxylated C₈-C₁₈ alkyl ether sulfate salts having the formula R(OC₂H₄)ₙ OSO₃M wherein n is 1 to 12, preferably 1 to 5, and M is an ammonium cation or a metal cation selected from the group consisting of sodium, potassium, magnesium or a mono-, di- and triethanol ammonium ions. The alkyl sulfates may be obtained by sulfating the alcohols obtained by reducing glycerides of coconut oil or tallow or mixtures thereof and neutralizing the resultant product.

The ethoxylated alkyl ether sulfates are obtained by sulfating the condensation product of ethylene oxide with a C₈-C₁₈ alkanol and neutralizing the resultant product. The alkyl sulfates may be obtained by sulfating the alcohols obtained by reducing glycerides of coconut oil or tallow or mixtures thereof and neutralizing the resultant product. On the other hand, the ethoxylated alkyl ether sulfates are obtained by sulfating the condensation product of ethylene oxide with a C₈-C₁₈ alkanol and neutralizing the resultant product. The ethoxylated alkyl ether sulfates differ from one another in the number of moles of ethylene oxide reacted with one mole of alkanol. Preferred alkyl sulfates and preferred ethoxylated alkyl ether sulfates contain 10 to 16 carbon atoms in the alkyl group.

The ethoxylated C₈-C₁₂ alkylphenyl ether sulfates containing from 2 to 6 moles of ethylene oxide in the molecule also are suitable for use in the inventive compositions. These surfactants can be prepared by reacting an alkyl phenol with 2 to 6 moles of ethylene oxide and sulfating and neutralizing the resultant ethoxylated alkylphenol. Other suitable anionic surfactants are the ethoxylated C₉-C₁₅ alkyl ether carboxylates having the structural formula R(OC₂H₄)ₙOX COOH wherein n is a number from 4 to 12, preferably 5 to 10 and X is selected from the group consisting of 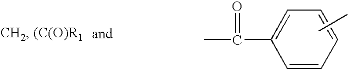
wherein R₁ is a C₁-C₃ alkylene group. Preferred compounds include C₉-C₁₁ alkyl ether polyethenoxy (7-9) C(O)CH₂CH₂COOH,
C₁₃-C₁₅ alkyl ether polyethenoxy (7-9) 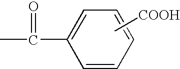
and C₁₀-C₁₂ alkyl ether polyethenoxy (5-7) CH2COOH. These compounds may be prepared by considering ethylene oxide with appropriate alkanol and reacting this reaction product with chloracetic acid to make the ether carboxylic acids as shown in U.S. Pat. No. 3,741,911 or with succinic anhydride or phthalic anhydride. Obviously, these anionic surfactants will be present either in acid form or salt form depending upon the pH of the final composition, with salt forming cation being the same as for the other anionic surfactants.

Of the foregoing non-soap anionic surfactants used in forming the instant compositions, the preferred anionic surfactant is a sodium salt of a C₈-C₁₈ linear alkyl benzene sulfonate.

Highly suitable cosurfactants for the instant compositions over temperature ranges extending from 5° C. to 43° C. for instance are glycerol, ethylene glycol, water-soluble polyethylene glycols having a molecular weight of 300 to 1000, polypropylene glycol of the formula HO(CH₃CHCH₂O)ₙH wherein n is a number from 2 to 18, mixtures of polyethylene glycol and polypropyl glycol (Synalox) and mono C₁-C₆ alkyl ethers and esters of ethylene glycol and propylene glycol having the structural formulas R(X)ₙOH and R₁(X)ₙOH wherein R is C₁-C₆ alkyl group, R₁ is C₂-C₄ acyl group, X is (OCH₂CH₂) or (OCH₂(CH₃)CH) and n is a number from 1 to 4, diethylene glycol, triethylene glycol, an alkyl lactate, wherein the alkyl group has 1 to 6 carbon atoms, 1methoxy-2-propanol, 1methoxy-3-propanol, and 1methoxy 2-, 3- or 4-butanol. Preferred cosurfactants are propylene glycol n-butyl ether and dipropylene glycol n-butyl ether.

A wide variety of materials can be used as the substrate provided that the substrate is water insoluble. Wovens, hydroentangled substrates, nonwovens, sponges and various cellulosics materials are all suitable as water insoluble substrates.

Hydraspun™ which is manufactured by the Dexter Corporation is a suitable nonwoven substrate. Hydraspun™ comprises about 60 wt. % to 95% of wood pulp fabric, 2.5 wt. % to 20 wt. % of viscose fibers and 2.5 wt. % to 20 wt. % of polyester fibers.

A useful fabric manufactured by Jacob-Holm-Lidro Rough (Soultz, France) comprises a layer 65 wt. % of viscous rayon and 35 wt. % polyester hydroentangled Spunlace and a scribby layer of hydroentangled bonded polyester.

A composite which is manufactured by Texel (Quebec, Canada) comprises a layer of coarse of 100% polypropylene which is needle punched, an absorbent center layer of cellulose fibers and a fine layer of polyester fibers, wherein the three layers are needle punched together. The polypropylene layer ranges from 1.5 to 3.5 oz./sq. yard of the composite. The fine polyester layer ranges from 0.5 to 2.0 oz./sq. yard of the composite.

Little Rapids Corporation (Schwano, Wis.) manufactures a nonwoven water insoluble substrate which is 100 wt. % of cellulose Wading grade. American Non-Woven Corporation Manufactures NB701.28-W/R which is 100 wt. % of needle punched polypropylene. Ahlstrom Fibre manufactures a blend of cellulose and synthetic Hydrospun 8579 fibers. PGI Nonwoven Polyndy Corporation manufactures a composite of about 70 wt. % of viscose fibers and about 30 wt. % of PES Code 9861.

Kimberly Clark (Neenah, Wis.) manufactures a composite dual textured material which comprises a coarse melt blown polypropylene, polyethylene or polyester and high loft polyester, wherein the layers are either laminated together, joined together by adhesive means or coprocessing the two layers. The coarse melt blown layer ranges from 1 to 3 oz. per sq. yard of the composite while the spun bond layer ranges from 1 to 3 oz. per sq. yard of the composite.

The substrate of the present invention may be a single layer such as Hydraspun or Spunlace or the water insoluble substrate may be multiple layers may be ultrasonically bonded after applying the coating of one or more layers. Alternatively, the multiple layers may be ultrasonically bonded after applying the coating of one or more of the layers. Alternatively layers may be bonded together by needle punch, thermal bonding, chemical bonding or sonic bonding prior to applying the coating and/or impregnation.

Another substrate within the scope of this invention is a non-woven formed from about 70 wt % to about 90 wt % of wood pulp and about 5 wt % to about 30 wt % of a chemical binder made by the Airlaid process. Typical examples of binders are ethylene vinyl acetate polymer (EVA) and styrene butadiene copolymer.

The following example illustrate the dust control wipe of the described invention. Unless otherwise specified, all percentages are by weight. The exemplified is illustrative only and do not limit the scope of the invention.

Preparation of the Wipes

The wipes were prepared by impregnating Hydraspun wipes from Alshstrom (17×26 cm) with an aqueous liquor (impregnation level=2 g liquor/g dry wipe); the said liquor containing 1.5% ethanol (99% grade), 0.5% dipropylene glycol, 1.785% sodium lauryl sulfate (28% grade), 0.0335 choline chloride (75% grade), 0.1% perfume (Vivair Mod from IFF) and water balance. The impregnation was hand-made; it was carried out by pipetting and homogeneously spreading the appropriate liquor amount on each individual dry wipe which had been previously weighted. To complete the liquor distribution, the so-prepared wipes were folded and kept a few hours in sealed plastic envelopes.

The impregnation level is preferably from about 2.0 to about 3.0 grams liquor/gram dry wipe.

### EXAMPLE 1

The following composition was made by simple mixing at 25° C. and impregnated into the wipe by the previously described process:

| | A |
|---|---|
| | (wt. %) |
| Ethanol | 0.99 |
| Dipropylene glycol butyl ether | 0.33 |
| Sodium lauryl sulfate | 0.33 |
| Perfume | 0.07 |
| Choline chloride | 0.02 |
| Water | 64.93 |
| Spunlace nonwoven fabric | 33.33 |

Prevention of Dust Anchoring
Test Methodology:

Melamine coated wood tiles were used as a model surface (15×20 cm²). The product to be tested was applied on a half tile by wiping the wipe for about 15 strokes. The tile was allowed to rest for 10 minutes for complete drying, and then dusted with dust from a vacuum cleaner bag that was sifted and sprinkled above the sloped tile. If the treatment is effective, the dust does not remain on the treated part of the wood pane. Five replicates were realized for each type of treatment. All the panes were submitted to a visual assessment. The score is given for the treated part; the untreated part is the reference with a 0 score. The higher the score, the better the prevention of the dust anchoring. A score of −10 corresponds to a surface that is absolutely clean and free from dust.

Performance Ratings:

| | Score |
|---|---|
| Untreated tile = reference | 0 |
| Water | 0 |
| Treatment with-a commercial dusting wipe | 0.33 |
| Treatment with composition A | 3.80 |

The prototype (A) provided a good dust prevention effect (score 3.8) which corresponds to a reduction of the dust anchoring to the surface. The commercial dusting wipe product provided a significantly lower dust prevention score.

1. A dust control wipe comprising by weight:
(a) from about 15% to about 60% of a water insoluble substrate; and
(b) from about 40% to about 85% of a dust control composition which comprises by weight:
(i) from about 0.1% to about 5.0% of at least one anionic surfactant; and
(ii) from about 0.01% to about 4.0% of a dust control agent, which is selected from the group consisting of alkylolamine methosulfate and choline chloride.

2. The wipe according to claim 1 wherein said anionic surfactant is a sulfate surfactant.

3. The wipe according to claim 2 further including a C₂-C₄ alkanol.

4. The wipe according to claim 3 further including a water soluble glycol ether cosurfactant.

5. The wipe according to claim 4 further including a perfume.

6. The wipe according to claim 5 wherein said water insoluble substrate is a nonwoven fabric.

7. The wipe according to claim 1, wherein said anionic surfactant is a sulfonate surfactant.

8. The wipe according to claim 7 further including an alkanol.

9. The wipe according to claim 8 further including a water soluble glycol ether cosurfactant.

10. The wipe according to claim 9, further including a perfume.

11. The wipe according to claim 10, wherein said water insoluble substrate is a nonwoven fabric.

12. The wipe according to claim 1 containing from about 0.01% to about 1.0% of said dust control agent.

13. The wipe accordingly to claim 1 further including water.

14. A method of treating a surface for the prevention of dust deposit thereon comprising contacting the surface to be treated with the dust control wipe in accordance with claim 1.
